(19) United States
(12) Patent Application Publication
(10) Pub. No.: US 2016/0057428 A1
(43) Pub. Date: Feb. 25, 2016

(54) SYSTEMS AND METHODS FOR BLURRINESS BOUNDING FOR VIDEOS

(71) Applicant: Facebook, Inc., Menlo Park, CA (US)

(72) Inventor: John Torres Fremlin, San Francisco, CA (US)

(21) Appl. No.: 14/465,454

(22) Filed: Aug. 21, 2014

(51) Int. Cl. H04N 19/126; H04N 19/86; H04N 19/184; H04N 19/87; H04N 19/147; H04N 19/48; H04N 19/70

(52) U.S. Cl. CPC H04N 19/126; H04N 19/48; H04N 19/86; H04N 19/70; H04N 19/87; H04N 19/147; H04N 19/184

(57) ABSTRACT

Systems, methods, and non-transitory computer-readable media receive source video content, encode the source video content by a first encoding process to produce compressed video content, apply edge detection to the compressed video content to produce first edge-detected video content, and encode the first edge-detected video content by a second encoding process to produce first encoded video content. The systems, methods, and non-transitory computer-readable media may further equalize the source video content by an equalization algorithm to produce equalized video content, apply edge detection to the equalized video content to produce second edge-detected video content, and encode the second edge-detected video content by the second encoding process to produce second encoded video content. The systems, methods, and non-transitory computer-readable media may compare the first encoded video content and the second encoded video content, and adjust the first encoding process based on the comparison.

### FIELD OF THE INVENTION

The present technology relates to the field of multimedia processing and, more particularly, provides techniques for addressing blockiness or blurriness in videos.

### BACKGROUND

At present, people have multiple ways in which to access multimedia content such as images, audio, and video. The multimedia content may be captured by cameras, sound recorders, video recorders, and the like, which may be part of a mobile phone device, such as a smartphone. A mobile device, for instance, may include a camera and video capturing software that enables a user to record or capture videos using the camera included with the mobile device. The videos may be stored on the mobile device, or on the Internet, and accessed at a later time. In another example, a user may have access to a video that was downloaded to the mobile device in contrast to video that was captured by the mobile device.

In some cases, an Internet social networking service can enable users to upload and share multimedia content with members of the social networking service. Often, the shared videos or other multimedia content are stored at the social networking service, and members of the social networking service can access the multimedia content from the social networking services storage. To decrease the amount of resources needed to store multimedia content at the social networking service, to communicate (e.g., download or stream) multimedia content to members of the social networking service, or both, the social networking service can often compress the multimedia content (e.g., using a codec or similar algorithm) to reduce the data size of the multimedia content for storage or communication purposes.

### SUMMARY

To allow for realization of optimization objectives of a social networking system, embodiments of the invention include systems, methods, and computer readable media configured to provide enhanced video encoding compatible with the social networking system.

In various aspects of the present disclosure, systems, methods, and non-transitory computer-readable media are provided that receive source video content, encode the source video content by a first encoding process to produce compressed video content, apply edge detection to the compressed video content to produce first edge-detected video content, and encode the first edge-detected video content by a second encoding process to produce first encoded video content. The systems, methods, and non-transitory computer-readable media may further equalize of the source video content by an equalization algorithm to produce equalized video content, apply edge detection to the equalized video content to produce second edge-detected video content, and encode the second edge-detected video content by the second encoding process to produce second encoded video content. The systems, methods, and non-transitory computer-readable media may compare the first encoded video content and the second encoded video content, and adjust the first encoding process based on the comparison.

In some embodiments, the second encoding process comprises an H.264 encoding process. For example, the H.264 encoding process may comprise an H.264 intra encoding process.

In some embodiments, the equalization algorithm comprises a histogram equalization algorithm.

In some embodiments, equalizing the source video by the equalization algorithm comprises equalizing contrast of the source video.

In some embodiments, comparing the first encoded video content and the second encoded video content comprises comparing a first number of edges associated with the first encoded video content to a second number of edges associated with the second encoded video content.

In some embodiments, comparing the first encoded video content and the second encoded video content comprises comparing a first data size associated with the first encoded video content to a second data size associated with the second encoded video content. In some embodiments, a first data file comprises the first encoded video content, the first data file has a first data file size, the first data size comprises the first data file size, a second data file comprises the second encoded video content, the second data file has a second data file size, and the second data size comprises the second data file size.

In some embodiments, adjusting the first encoding process based on the comparison comprises adjusting a target bit rate associated with the first encoding process.

In some embodiments, adjusting the first encoding process based on the comparison comprises adjusting a target file size associated with the first encoding process.

In some embodiments, adjusting the first encoding process based on the comparison comprises adjusting the first encoding process when the comparison indicates a difference between the first encoded video content and the second encoded video content exceeds an upper bound. For example, a first number of edges associated with the first encoded video content may be bounded by the upper bound, and the upper bound may be greater than one hundred and one percent of a second number of edges associated with the second encoded video content.

In some embodiments, adjusting the first encoding process based on the comparison comprises adjusting the first encoding process when the comparison indicates a difference between the first encoded video content and the second encoded video content exceeds a lower bound. For example, a first number of edges associated with the first encoded video content may be bounded by the lower bound, and the lower bound may be less than ninety-eight percent of a second number of edges associated with the second encoded video content.

In some embodiments, adjusting the first encoding process based on the comparison comprises increasing a target bit rate associated with the first encoding process when the comparison indicates a difference between the first encoded video content and the second encoded video content exceeds a lower bound or an upper bound.

In some embodiments, the computer-implemented method is performed iteratively until the comparison indicates a difference between the first encoded video content and the second encoded video content is within an upper bound.

In some embodiments, applying the edge detection to the compressed video content comprises applying a Canny edge detector to the compressed video content, applying the edge detection to the equalized video content comprises applying the Canny edge detector detection to the equalized video content, or both.

In some embodiments, the compressed video has a video quality metric corresponding to a structural similarity (SSIM) index of 0.975 or higher.

Many other features and embodiments of the invention will be apparent from the accompanying drawings and from the following detailed description.

### BRIEF DESCRIPTION OF THE DRAWINGS

FIG. 1 illustrates an example multimedia content module configured to process multimedia content according to an embodiment of the present disclosure.

FIG. 2 illustrates an example video content module, as shown in FIG. 1, according to an embodiment of the present disclosure.

FIG. 3 illustrates an example video processing module, as shown in FIG. 2, according to an embodiment of the present disclosure.

FIG. 4 illustrates an example data flow during video encoding by the video processing module shown in FIG. 3, according to an embodiment of the present disclosure.

FIG. 5 illustrates an example method for encoding a video according to an embodiment of the present disclosure.

FIG. 6 illustrates a network diagram of an example system that can be utilized in various embodiments for video encoding according to an embodiment of the present disclosure.

FIG. 7 illustrates an example of a computer system that can be used to implement one or more of the embodiments described herein according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

Multimedia content can be stored and utilized in an electronic or digital format, such as a data file, which is playable or otherwise accessible by one or more computer systems. The multimedia data file (i.e., multimedia file) can be stored at one or more data stores to be accessed or otherwise used at a subsequent time. As the stored multimedia file has an associated data size, the stored multimedia file requires computing resources when being stored (e.g., on the one or more data stores) and when being communicated over a network (e.g., network bandwidth).

Generally, the contents of a multimedia file can affect a file size of the multimedia file. For example, a higher quality video (e.g., with higher resolution, with better audio, etc.) can take up more space than a relatively lower quality video. In another example, a longer video (e.g., playback length) can use up more space than a shorter video. It therefore follows that as the length or quality of video files increase, the computing resources required to store or communicate the video files can also increase.

A video multimedia file (i.e., a video file, a video) can be encoded in one or more encoding processes and can refer to a process in which a given video is organized, prepared, and/or modified in accordance with given specifications (e.g., properties, settings, parameters, etc.). Encoding the video can convert the video from one format to another format, or from one set of specifications to another set of specifications. In doing so, the video (or an encoded version of the video) can be made compatible with different devices and systems. Moreover, encoding a video can reduce the amount of space required to store the video or communicate the video over computer network (e.g., a mobile device over a cellular network). Accordingly, the process of encoding videos can enable the videos to be accessible by various devices or systems as well as reduce the file sizes of the videos.

For instance, a video can be encoded at a particular bit rate and the bit rate can indicate a quantity of data used to represent the video. Accordingly, the bit rate at which a video is encoded can indicate the quantity of data used to represent the encoded video. When more data is used to encode a video (e.g., when the video is encoded at a higher bit rate), the quality of the video can increase but the file size of the video increases as well. Conversely, when less data is used to encode the video (e.g., when the video is encoded at a lower bit rate), the file size of the video decreases but the quality of the video can decrease as well. As a result, videos that have better quality can cost require more computing resources (e.g., for storage or communication over a network), while videos that have poorer quality can require less computing resources.

When source video is encoded to a compressed video at a bit rate that reduces the overall size of the video content, the resulting compressed video is often compared with the source video to determine the level of similarity, which in turn may represent the amount of quality loss that results from the encoding process. A structural similarity (SSIM) index is just one example method for measuring the similarity between the two videos. Various other video quality metrics, evaluation methods, or approaches for determining similarity between two videos can also be utilized. Determining the level of similarity between the source and resulting videos can facilitate an adjustment to the encoding process. For instance, a bit rate may be adjusted to achieve a target video quality metric, which can include, but is not limited to, a structural similarity (SSIM) index, a multi-scale structural similarity (MS-SSIM) index, or a peak signal-to-noise ratio (P SNR), etc. After the bit rate has been adjusted for the encoding process, the encoding process can be performed on the source video as a subsequent pass (e.g., a second pass) and the resulting compressed video will have a higher (or lower) bit rate, as desired.

Unfortunately, such video quality metrics are not always the best methods for measuring quality of a resulting compressed video. For instance, at times a compressed video may be encoded at a lower bit rate than desired, such as when the SSIM value is misleadingly high (e.g., 0.975) and, as a result, the bit rate of the encoding process is not adequately adjusted to address for blockiness or blurriness that may still be present in the compressed video. A misleading SSIM value or other video quality metric may result in instances, for example, where content in the source video includes large amounts of blank frames (e.g., completely black frames or solid colored frames), which will ultimately be encoded perfectly or nearly perfectly in the compressed video. Large amounts of blank frames might be found at the start or end of content in the source video, and might also be found between transitions (e.g., between scenes in a movie). Accordingly, a compressed video resulting from a source video having large amount of blank frames can have a SSIM, or other video quality metric, that indicates higher content similarity between the two videos than is visually present in the compressed video.

As result of a misleading video quality metric (e.g., misleadingly high SSIM value), compressed video may be produced using an encoding process at a lower bit rate than would otherwise be desirable. Consequently, the compressed video would lack sufficient bits to properly represent the source video content. This can lead to blockiness or blurriness to be present in the content of the compressed video.

The inventions discussed herein provide systems and methods for measuring for blockiness or blurriness in a compressed video. The encoding process can be appropriately adjusted in addition to, or as an alternative to, adjustments to the encoding process based on SSIM or some other video quality metric. For some embodiments, adjustments to the encoding process based on measuring the blockiness or blurriness of the compressed video can mitigate or otherwise address the presence of blockiness or blurriness in the compressed video. For some embodiments, a source video content is encoded to a compressed video content using a first encoding process at a bit rate that reduces data size while addressing blockiness or blurriness issues that may otherwise damage the user experience of the compressed video.

For various embodiments, the blockiness or blurriness of compressed video content may be measured by applying edge detection to the compressed video content and encoding the resulting content using a second encoding process such that each frame is encoded as a static image (e.g., MPEG image). The first encoded video content that results can be compared against second encoded video content. The second encoded video content can be produced by applying image equalization (e.g., histogram equalization) to the source video content, applying edge detection to video content resulting from the image equalization, and encoding the video content resulting from the application of edge detection using the second encoding process such that each frame is encoded as a static image.

According to some embodiments, the blockiness or blurriness of the compressed video content resulting from the first encoding process is measured by comparing the first encoded video content against the second encoded video content. For some embodiments, if the first encoded video content has a greater file size than the second encoded video content, the first encoded video content is considered to include more encoded edges than the second encoded video content. Conversely, for some embodiments, if the second encoded video content has a greater file size than the first encoded video content, the first encoded video content is considered to have less encoded edges than the second encoded video content. The difference in encoded edges between the first encoded video content and the second encoded video content can be a measure of blockiness or blurriness in the compressed video content.

To control blurriness or blockiness in the compressed video content, in various embodiments, the desired data size of the first encoded video content is bounded to a lower bound and an upper bound in comparison to the data size of the second encoded video content. For example, the desired data size of the first encoded video content may be bounded to no less than 98 percent smaller than the data size of the second encoded video content, the desired data size of the first encoded video content may be bounded to no more than 101 percent larger than the data size of the second encoded video content, or both. In the event that the lower bound or upper bound is exceeded, the blockiness or blurriness of the compressed video may be considered unacceptable, and the first encoding process used to produce the compressed video from the source video may be adjusted (e.g., iteratively) until the data size of the first encoded video content falls within the bound of the lower and upper bound. The first encoding process used to produce the compressed video from the source video may be adjusted by adjustment of the bit rate. For instance, if the upper or lower bound is exceeded, the bit rate of the first encoding process can be increased. Depending on the embodiment, the data size compared between the first encoded video content and the second encoded video content may include the size of their respective frames or the size of the files respectively storing the video content.

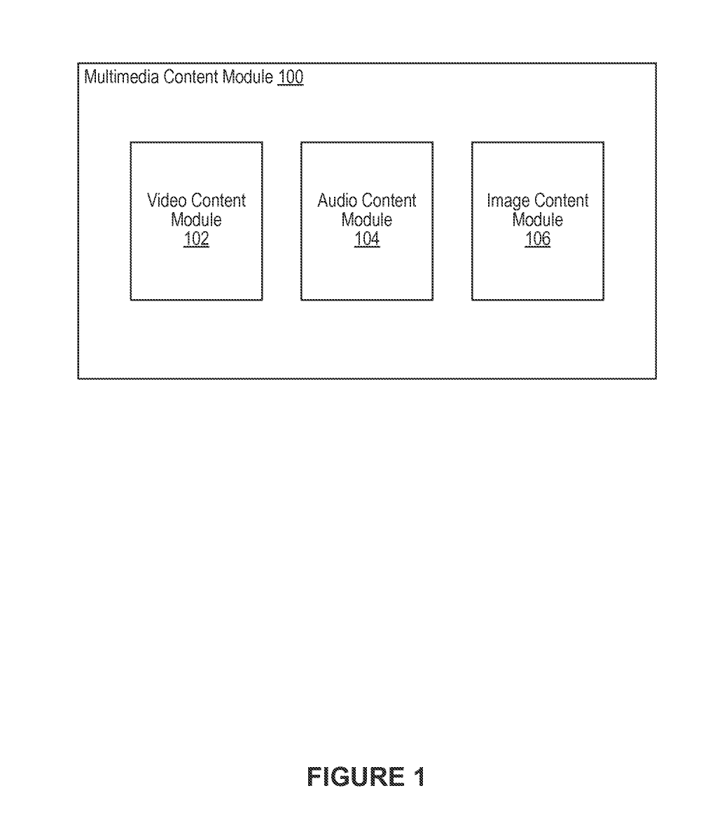

FIG. 1 illustrates an example multimedia content module 100 configured to process multimedia content according to an embodiment of the present disclosure. As described herein, multimedia content can include, but is not limited to, images, audio, video, or any combination thereof. As shown, the multimedia content module 100 can comprise a video content module 102, an audio content module 104, and an image content module 106. For some embodiments, the video content module 102 is configured to process or otherwise handle video content that is received or acquired by the multimedia content module 100. Likewise, for some embodiments, the audio content module 104 is configured to process or otherwise handle audio content, and the image content module 106 is configured to process or otherwise handle image content. Depending on the embodiment, the multimedia content module 100 can include additional modules to facilitate or otherwise assist in processing and handling of image, audio, video, and other types of multimedia content.

In various embodiments, the video content module 102 is configured to receive source video content and process such source video content in accordance with the present disclosure. The source video content may be raw video content or video content that was previously encoded using a particular encoding algorithm (e.g., codec). The source video content may comprise a video file, such as one containing video content captured by and subsequently uploaded from a user computing system, such as a smart-phone. The video content module 102 may retrieve or otherwise receive the source video content from a remote or local data store, and then begin processing the source video content.

In some embodiments, the video content module 102 is configured to provide a metric for blockiness or blurriness in a compressed video and correcting for blockiness or blurriness when encoding a source video to a compressed video. For some embodiments, the video content module 102 facilitates encoding of a source video content to a compressed video content using a first encoding process at a bit rate that reduces data size while addressing blockiness or blurriness issues that may otherwise damage the user experience in relation to the compressed video.

After source video content is encoded to compressed video content using a first encoding process, the video content module 102 can measure the blockiness or blurriness of the compressed video content by applying edge detection to the compressed video content and encoding the resulting content using a second encoding process such that each frame is encoded as a static image (e.g., MPEG image). The video content module 102 can compare the first encoded video content that results against second encoded video content.

The video content module 102 produces the second encoded video content by applying image equalization (e.g., histogram equalization) to the source video content, applying edge detection to video content resulting from the image equalization, and encoding the video content resulting from the application of edge detection using the second encoding process such that each frame is encoded as a static image. By comparing the first encoded video content against the second encoded video content, the video content module 102 can ultimately measure or otherwise determine the blockiness or blurriness of the compressed video content encoded by the first encoding process.

Based on the comparison, the video content module 102 can adjust the first encoding process. The adjustment can be such that when the first encoding process is used during a subsequent iteration of converting the source video content to the compressed video content, the compressed video content that results from the subsequent iteration has less blockiness or blurriness than a prior iteration of converting the source video content to the compressed video content using the first encoding process (e.g., prior iteration where the first encoding process was used before the adjustment). As described herein, the adjustment to the first encoding process can include, but is not limited to, adjustment to a target bit rate, a target file size, a target video quality metric (e.g., SSIM), or the like. The video content module 102 may perform multiple iterations of encoding and comparing the first and second encoded video contents and adjusting the first encoding process until the comparison of the first and second encoded video contents indicates that the difference between the first and second encoded video contents falls within an upper bound, within a lower bound, or between a upper bound and a lower bound. For instance, the video content module 102 may perform multiple iterations until the first encoded video content contains a number of edges that is equal to or within 98 percent or 101 percent of the number of edges contained in the second encoded video content.

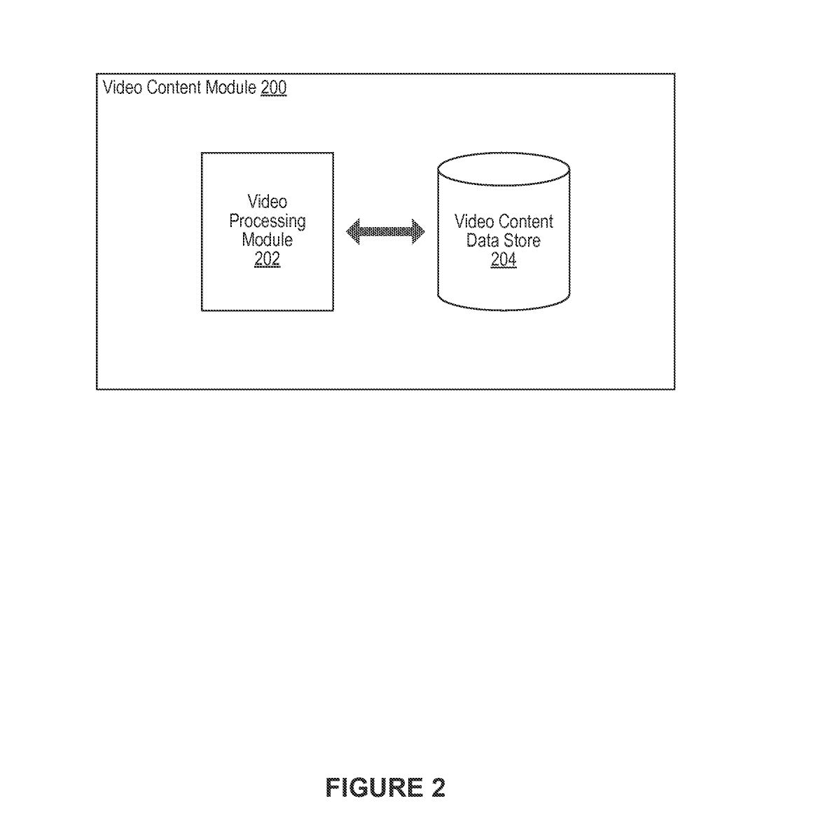

FIG. 2 illustrates an example video content module 200, as shown in FIG. 1 (e.g., video content module 102), according to an embodiment of the present disclosure. The video content module 200 can comprise a video processing module 202 and a video content data store 204. The video processing module 202 can, for example, process, access, modify, or otherwise handle a given video in accordance with embodiments described herein. The video content data store 206 can store video content, such as source video content, compressed video content generated by an encoding process, and intermediate video content generated by the video processing module 202 as it handles video content. The video content may be stored on the video content data store 206 as one or more video files having similar or different video formats.

In some embodiments, the video processing module 202 is coupled or communicatively connected (e.g., over a computer network) to the video content data store 204 such that the video processing module 202 and the video content data store 204 can communicate with each other. In some instances, the video processing module 202 can access one or more videos that are stored at the video content data store 204. In additional instances, the video processing module 202 can provide one or more videos (e.g., compressed video content) to be stored at the video content data store 204. This may occur, for instance, when source video content is received by the video processing module 202 and encoded to compressed video content during one or more iterations. The compressed video content resulting during one or more of those iterations can be can be stored at the video content data store 204.

In some cases, the video content data store 204 can be configured to store multiple versions (e.g., copies) of particular video as well as to store information about how the multiple versions of the particular video content are related. For instance, the video content data store 204 may store an original version of source video content (e.g., original source video content); a version of compressed video content encoded from the source video content at a particular bit rate; and intermediate video content generated by the video processing module 202 from the source video content, the compressed video content, or both. Intermediate video content can include, but not limited to, a version of the compressed video content after edge-detection; a version of the compressed video content after edge-detection and encoding by a second encoding process, a version of the source video content after histogram equalization, a version of the source video content after histogram equalization and edge-detection, and a version of the source video content after histogram equalization, edge-detection, and encoding by a second encoding process. The video content data store 206 can also include information indicating derivative relations between video content.

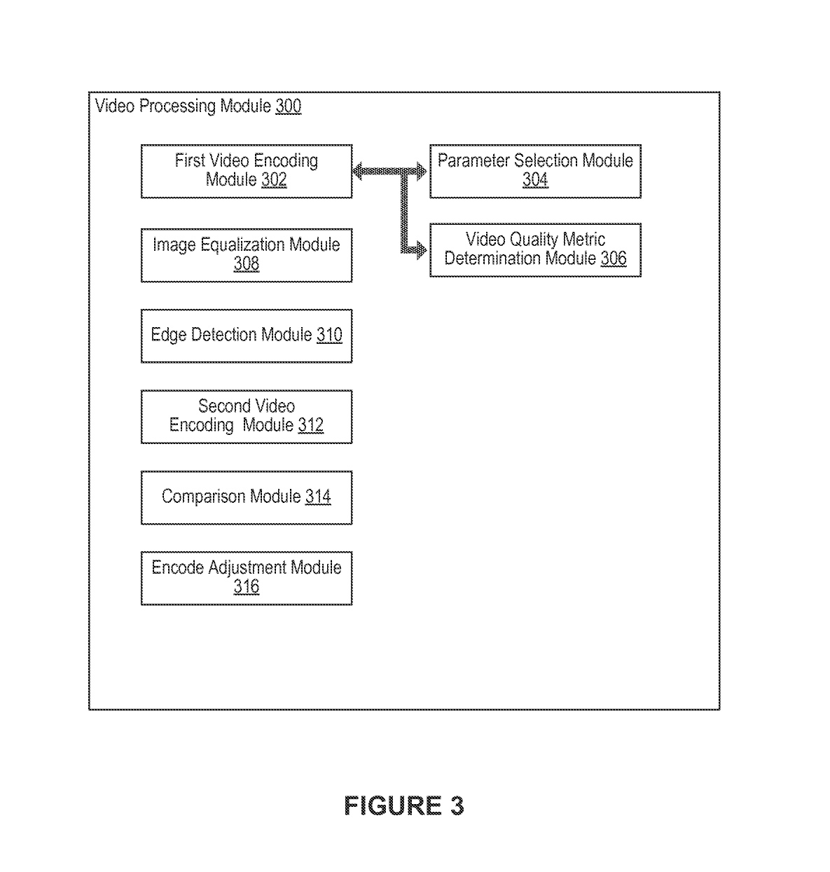

FIG. 3 illustrates an example video processing module 300, as shown in FIG. 2 (e.g., video processing module 202) as shown in FIG. 2, according to an embodiment of the present disclosure. As shown, the video processing module 300 can comprise a first video encoding module 302, a parameter selection module 304, and a video quality metric determination module 306, an image equalization module 308, an edge detection module 310, a second video encoding module 312, a comparison module 314, and an encode adjustment module 316. As also shown in FIG. 3, the first video encoding module 302, the parameter selection module 304, and the video quality metric determination module 306 can be configured to be capable of communicating with one another.

In some embodiments, the first video encoding module 302 is configured to perform or otherwise facilitate performance of a first encoding process with respect to a video content. For example, the first video encoding module 302 can be utilized to encode source video content, at a certain bit rate, to compressed video content. In some embodiments, the bit rate at which the first video encoding module 302 encodes to encode video content is determined or selected by the parameter selection module 304. The parameter selection module 304 will be discussed in more detail below.

The video quality metric determination module 306 may be configured to calculate or otherwise determine for compressed video content a video quality metric relative to source video content from which the compressed video content is encoded. As described herein, the video quality metric can be used to measure a level of similarity (e.g., pixel similarity, perceived visual similarity, frame-by-frame image quality similarity, etc.) between two videos and, in particular, a compressed video and a source video from which the compressed video is encoded. Given a first video and a second video, the video quality metric can be used to determine how similar the second video is to the first video. If the quality metric for the second video (relative to the first video) is higher, then the second video is likely more similar to the first video. Conversely, if the quality metric for the second video (relative to the first video) is lower, then the second video is likely less similar to the first video. In some instances, the quality metric can include, but is not limited to, at least one of a structural similarity (SSIM) index, a multi-scale structural similarity (MS-SSIM) index, or a peak signal-to-noise ratio (P SNR), etc. Various other video quality metrics, evaluation methods, or approaches for determining similarity between two videos also exist.

As discussed herein, in various embodiments, a metric for blockiness or blurriness in a compressed video is provided, which can be used to correct for the blockiness or blurriness by adjusting the encoding process used to encode a source video to the compressed video. Additionally, in various embodiments, the metric is provided or used to correct for blockiness or blurriness present in the compressed video despite a video quality metric, which may be provided by the video quality metric determination module 306, indicates a high level of similarity between the compressed video and the source video.

The image equalization module 308 may be configured to receive video content and apply an equalization algorithm to the video content. For some embodiments, the image equalization module 308 is configured to equalize the contrast in the video content, and may do so using a histogram equalization algorithm.

The edge detection module 310 may be configured to receive video content and apply edge detection to the video content. In some embodiments, edge detection module 310 applies the edge detection by utilizing a Canny edge detector, which may be implemented as a filter.

The second video encoding module 312 may be configured to receive video content and encode the video content to encoded video content using a second encoding process. For some embodiments, the second encoding process utilized by the second video encoding module 312 is different from the first encoding process utilized by the first video encoding module 302, and may be different according to a parameter (e.g., target bit rate, target file size, etc.) or type (e.g., video format, codec, etc.). In some embodiments, the second encode process may be configured to be encode each frame of the video content as a static image. This may enable subsequent processes to better compare frames of the encoded video content to other encoded video content.

The comparison module 314 may be configured to receive two or more video content and compare the two or more video content. Depending on the embodiments, the comparison module 314 may be configured to determine pixel differences between the two or more video content (e.g., per frame), differences in frame size, or difference in data space occupied by each of the two or more video content.

The encode adjustment module 316 may be configured to adjust one or more parameters of a first encoding process utilized by the first video encoding module 302. Additionally, the encode adjustment module 316 may be configured to adjust the one or more parameters based on a comparison of video content as performed by the comparison module 314.

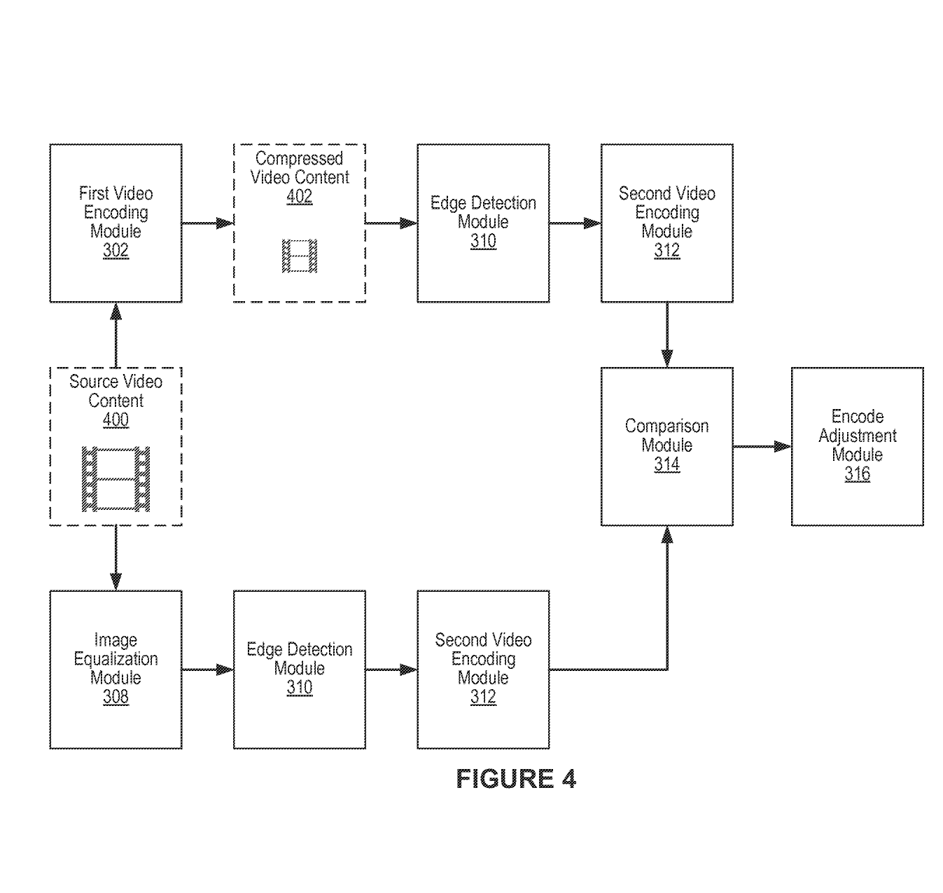

FIG. 4 illustrates an example data flow during video encoding by the video processing module 300 shown in FIG. 3, according to an embodiment of the present disclosure. As shown in FIG. 4, source video content 400 can be received by the first video encoding module 302, and the source video content 400 can also be received by the image equalization module 308.

As described herein, the first video encoding module 302 can encode the source video content 400 to compressed video content 402 using a first encoding process. The first video encoding module 302 may encode the source video content 400 to compressed video content 402 according to a first target bit rate, a first bit target file size, a first video quality metric, or the like. The compressed video content 402 can be provided to the edge detection module 310, which can apply edge detection to the compressed video content 402 to produce first edge-detected video content. For some embodiments, the edge detection module 310 applies edge detection to the compressed video content 402 by applying a Canny edge detector to the compressed video content 402.

Thereafter, the second video encoding module 312 may receive the first edge-detected video content from the edge detection module 310 and encode the first edge-detected video content to first encoded video content using a second encoding process. For some embodiments, the second encoding process is different from the first encoding process utilized by the first video encoding module 302. Additionally, in some embodiments, the second encoding process may be configured to encode each frame of the first edge-detected video content as a static image, such as an MPEG image. The second encoding process may comprise a H.264 encoding process, such as a H.264 intra encoding process. The second video encoding module 312 may provide the resulting first encoded video content to the comparison module 314 for further processing.

As also described herein, the image equalization module 308 may apply an image equalization module to the source video content 400 to produce equalized video content. In some embodiments, the image equalization module 308 equalizes the contrast of the source video content 400 to equalized video content. Additionally, for some embodiments, the image equalization module 308 may utilize a histogram equalization algorithm to equalize the global contrast of the source video content 400. The image equalization module 308 may provide the resulting equalized video content to the edge detection module 310. The edge detection module 310 can receive the equalized video content and apply edge detection to the equalized video content to produce second edge-detected video content. For some embodiments, the edge detection module 310 applies edge detection to the equalized video content by applying a Canny edge detector to the equalized video content.

Subsequently, the second video encoding module 312 may receive the second edge-detected video content from the edge detection module 310 and encode the second edge-detected video content to a second encoded video content using a second encoding process. As described herein, for some embodiments, the second encoding process is different from the first encoding process utilized by the first video encoding module 302. Depending on the embodiment, the second encoding process utilized by the second video encoding module 312 to encode the second edge-detected video content to a second encoded video content may be configured similarly to, or differently from, when the second encoding process is utilized by the second video encoding module 312 to encode the first edge-detected video content to first encoded video content. The second video encoding module 312 may provide the resulting second encoded video content to the comparison module 314 for further processing.

Upon receiving the first encoded video content and the second encoded video content from the second video encoding module 312, the comparison module 314 may compare the first encoded video content to the second encoded video content. Based on the comparison, the comparison module 314 may determine whether the first encoding process, utilized by the first video encoding module 302 to convert the source video content 400 to the compressed video content 402, should be adjusted. As described herein, for some embodiments, where the comparison indicates that a difference between the first encoded video content and the second encoded video content exceeds either a upper bound or a lower bound, or both, the comparison module 314 can inform or otherwise direct the encode adjustment module 316 to adjust one or more parameters of the first encode process for a subsequent iteration of the first encode process. For instance, the encode adjustment module 316 may be configured to adjust one or more of the first target bit rate to a second target bit rate, the first target file size to a second target file size, and the first video quality metric to a second video quality metric to address the difference between the first encoded video content and the second encoded video content exceeding either a upper bound or a lower bound. As described herein, the difference between the first encoded video content and the second encoded video content may exceed either an upper bound or a lower bound when the first encoded video content has an unacceptable or undesirable level of blockiness or blurriness.

For some embodiments, the comparison module 314 compares the data size of a file containing the first encoded video content to the data size of a file containing the second encoded video content. In doing so, the comparison module 314 can determine the number of edges contained in the first encoded video content relative to the number of edges contained in the second encoded video content.

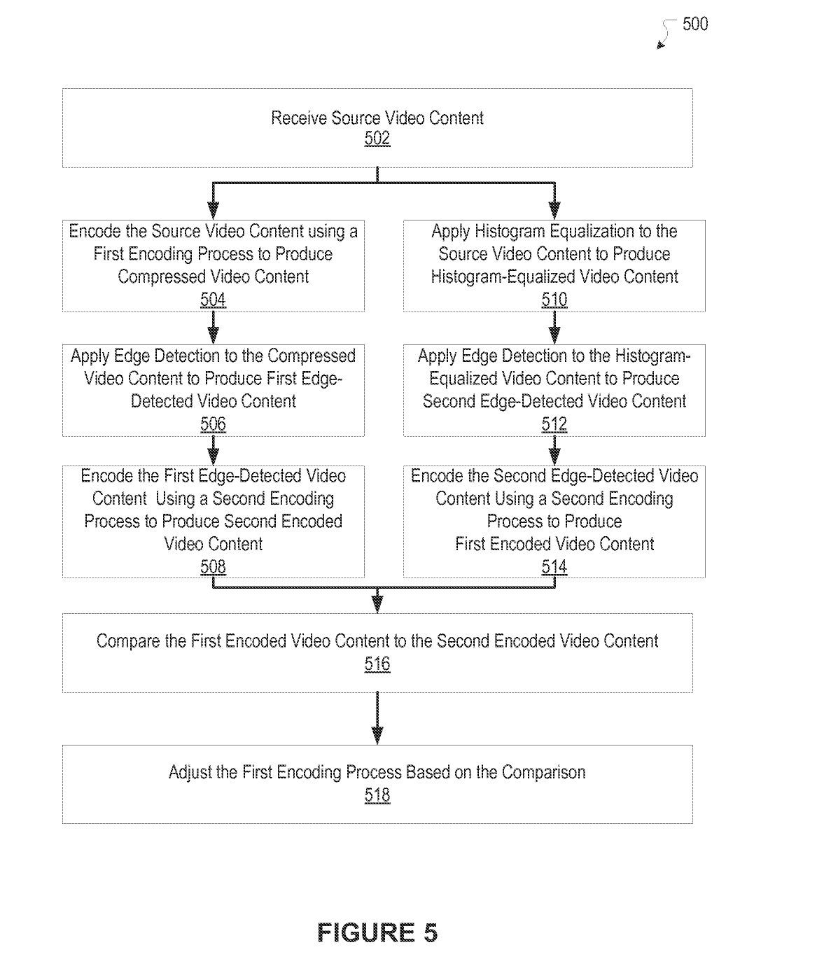

FIG. 5 illustrates an example method 500 for encoding a video according to an embodiment of the present disclosure. A person having ordinary skill in the art would recognize that there can be additional, fewer, or alternative steps performed in similar or alternative orders, or in parallel, within the scope of the various embodiments unless otherwise stated.

At block 502, the example method 500 can receive source video content. The source video content may be one uploaded to a social networking service from a user computing system, such as a smart-phone, and then subsequently stored on the social networking service for future access by one or members of the social networking service.

At block 504, the example method 500 can encode the source video content using a first encoding process to produce compressed video content. The first encoding process may include, but not be limited to, MPEG-2, MPEG-4, and H.264. The encoding process may encode, and thereby convert, the source video content to the compressed video content according to one or more parameters including, but not limited to, a target bit rate, a target file size, a target video quality metric (e.g., SSIM), and the like. The one or more parameters of the first encoding process may be adjusted based on the metric of blockiness or blurriness of the compressed video content as determined by the various embodiments described herein. For example, the target bit rate of the first encoding process may be increased if the metric of blockiness or blurriness determined for the compressed video content indicates an unacceptable or undesirable level of blockiness or blurriness in the compressed video.

At block 506, the example method 500 can apply edge detection to the compressed video content to produce first edge-detected video content. For some embodiments, applying the edge detection to the compressed video content comprises applying a Canny edge detector, or the like, to the compressed video content. The Canny edge detector may be implemented as an image filter.

At block 508, the example method 500 can encode the first edge-detected video content using a second encoding process to produce second encoded video content. For some embodiments, the second encoding process comprises a H.264 encoding process. Further, for some embodiments, the second encoding process utilized is configured such that each frame of the first edge-detected video content is encoded as a static image. For example, the second encoding process may comprise an H.264 intra encoding process configured to encode each frame of the first edge-detected video content as a MPEG image.

At block 510, the example method 500 can apply histogram equalization to the source video content to produce histogram-equalized video content. By applying the histogram equalization to the source video content, the contrast of the source video content can be adjusted, and may be adjusted to increase the global contrast of each frame of the source video content.

At block 512, the example method 500 can apply edge detection to the histogram-equalized video content to produce second edge-detected video content. For some embodiments, applying the edge detection to the histogram-equalized video content comprises applying a Canny edge detector, or the like, to the compressed video content. As described herein, the Canny edge detector may be implemented as an image filter.

At block 514, the example method 500 can encode the second edge-detected video content using a second encoding process to produce first encoded video content. Depending on the embodiment, the second encoding process utilized at block 514 may be similar or different to the second edge second encoding process utilized at block 508. For instance, the second encoding process utilized at block 514 comprises a H.264 encoding process, and may be configured such that each frame of the second edge-detected video content is encoded as a static image. Additionally, the second encoding process may comprise an H.264 intra encoding process configured to encode each frame of the first edge-detected video content as a MPEG image.

At block 516, the example method 500 can compare the first encoded video content to the second encoded video content. As described herein, the first encoded video content may be compared to the second encoded video content by comparing the data size of a file containing the first encoded video content to the data size of a file containing the second encoded video content. By such a comparison, the number of edges contained in the first encoded video content can be determined relative to the number of edges contained in the second encoded video content. The difference in number of edges between the first encoded video content and the second encoded video content can be utilized to measure the blockiness or blurriness present in the compressed video content produced at block 504. In some instances, the measure may indicate the presence of an undesirable or unacceptable level of blockiness or blurriness in the compressed video content even when a video quality metric indicates that the compressed video content has a high level of similarity to the source video content.

At block 518, the example method 500 can adjust the first encoding process based on the comparison. For some embodiments, one or more parameters of the first encoding process may be adjusted based on the comparison, including such parameters as a target bit rate, a target file size, a target video quality metric, and the like. Subsequent to block 518, another iteration of the example method 500 may be performed with the first encoding process as adjusted at block 518. With the adjustment, blockiness or blurriness present in the compressed video content can be mitigated or otherwise addressed. As discussed herein, blockiness or blurriness may be present in the compressed video content even when a video quality metric indicates a high level of similarity (e.g., SSIM of 0.0975 or higher) between the compressed video content and the source video content.

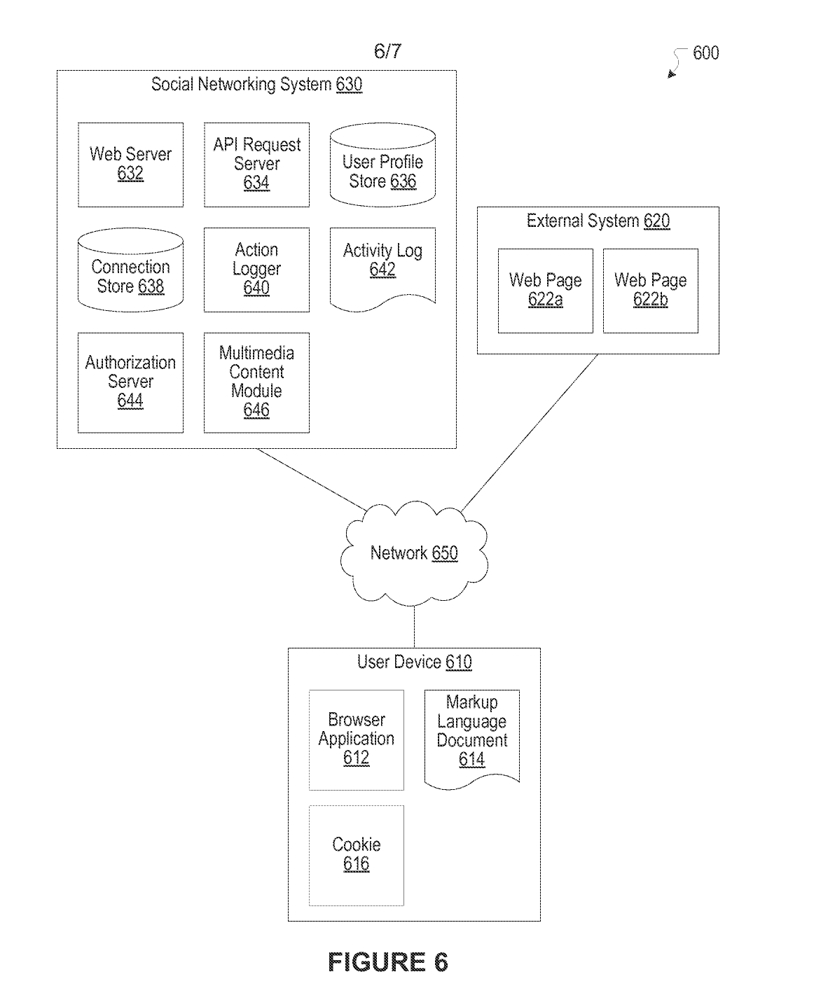

FIG. 6 illustrates a network diagram of an example system 600 that can be utilized in various embodiments for enhanced video encoding, in accordance with an embodiment of the present disclosure. The system 600 includes one or more user devices 610, one or more external systems 620, a social networking system 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 702.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, an authorization server 644, and a multimedia content module 646. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

The social networking system 630 can include a multimedia content module 646. The multimedia content module 646 can communicate with the user device 610 to upload multimedia content, such as one or more images, audios, and/or videos, from the user device 610 to the social networking system 630. For example, the multimedia content module 646 can receive a video uploaded from the user device 610 to the social networking system 630. The multimedia content module 646 can process or otherwise handle the video received from the user device 610. In an embodiment, the techniques described herein for measuring blockiness or blurriness in compressed video content, and for adjusting an encoding process to address blockiness or blurriness in compressed video content when encoding from source video content, can be performed by the multimedia content module 646 (or by at least a portion thereof). For some embodiments, the multimedia content module 646 included with the social networking system 630 facilitates adjustment of an encoding process utilized to encode source video content to compressed video content, and further facilitate performance of the adjusted encoding process, when an undesirable level of blockiness or blurriness is detected in the compressed video content produced by performance the encoding process before adjustment. The multimedia content module 646 may perform such operations despite a video quality metric misleadingly indicating a high level of similarity between the source video content and the compressed video content produced by the encoding process prior to adjustment.

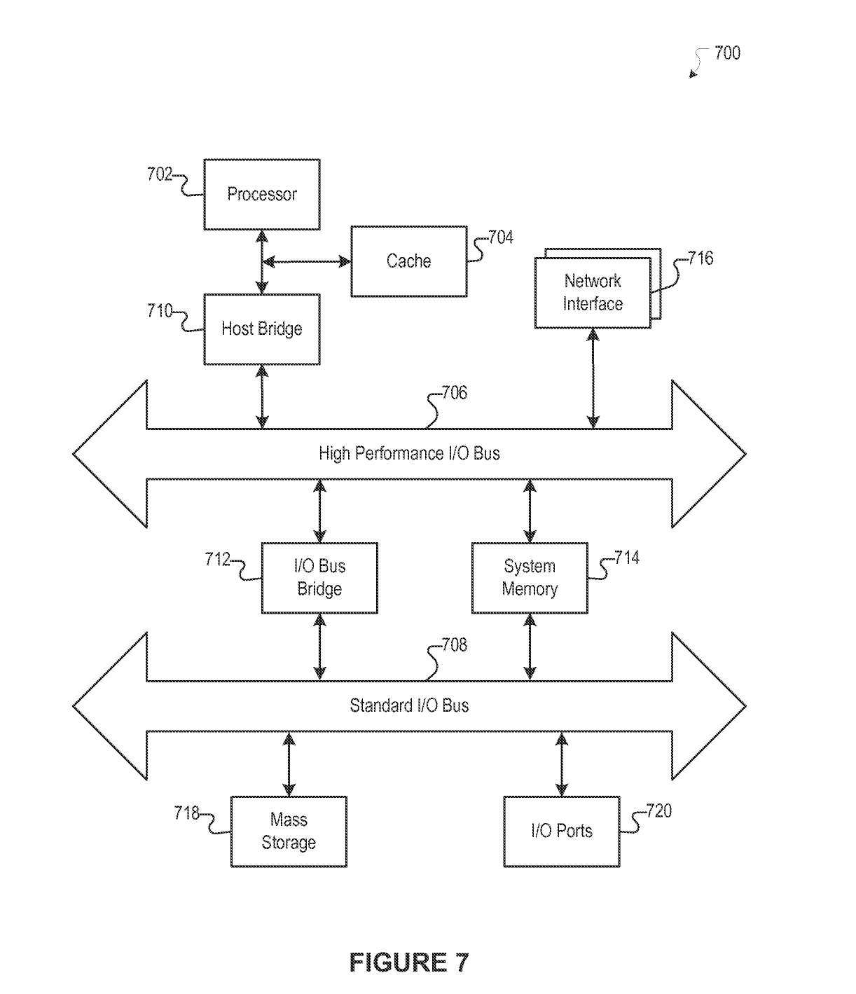

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 620, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Furthermore, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed:

1. A computer-implemented method comprising:
receiving, by a computer system, source video content;
encoding the source video content by a first encoding process to produce compressed video content;
applying edge detection to the compressed video content to produce first edge-detected video content;
encoding the first edge-detected video content by a second encoding process to produce first encoded video content;
equalizing the source video content by an equalization algorithm to produce equalized video content;
applying edge detection to the equalized video content to produce second edge-detected video content;
encoding the second edge-detected video content by the second encoding process to produce second encoded video content;
comparing the first encoded video content and the second encoded video content; and
adjusting the first encoding process based on the comparison.

2. The computer-implemented method of claim 1, wherein the second encoding process comprises an H.264 encoding process.

3. The computer-implemented method of claim 2, wherein the H.264 encoding process comprises an H.264 intra encoding process.

4. The computer-implemented method of claim 1, wherein the equalization algorithm comprises a histogram equalization algorithm.

5. The computer-implemented method of claim 1, wherein the equalizing the source video by the equalization algorithm comprises equalizing contrast of the source video.

6. The computer-implemented method of claim 1, wherein the comparing the first encoded video content and the second encoded video content comprises comparing a first number of edges associated with the first encoded video content to a second number of edges associated with the second encoded video content.

7. The computer-implemented method of claim 1, wherein the comparing the first encoded video content and the second encoded video content comprises comparing a first data size associated with the first encoded video content to a second data size associated with the second encoded video content.

8. The computer-implemented method of claim 7, wherein a first data file comprises the first encoded video content, the first data file has a first data file size, the first data size comprises the first data file size, a second data file comprises the second encoded video content, the second data file has a second data file size, and the second data size comprises the second data file size.

9. The computer-implemented method of claim 1, wherein the adjusting the first encoding process based on the comparison comprises adjusting a target bit rate associated with the first encoding process.

10. The computer-implemented method of claim 1, wherein the adjusting the first encoding process based on the comparison comprises adjusting a target file size associated with the first encoding process.

11. The computer-implemented method of claim 1, wherein the adjusting the first encoding process based on the comparison comprises adjusting the first encoding process when the comparison indicates a difference between the first encoded video content and the second encoded video content that exceeds an upper bound.

12. The computer-implemented method of claim 11, wherein a first number of edges associated with the first encoded video content is bounded by the upper bound, and the upper bound is greater than one hundred and one percent of a second number of edges associated with the second encoded video content.

13. The computer-implemented method of claim 1, wherein the adjusting the first encoding process based on the comparison comprises adjusting the first encoding process when the comparison indicates a difference between the first encoded video content and the second encoded video content that exceeds a lower bound.

14. The computer-implemented method of claim 13, wherein a first number of edges associated with the first encoded video content is bounded by the lower bound, and the lower bound is less than ninety-eight percent of a second number of edges associated with the second encoded video content.

15. The computer-implemented method of claim 1, wherein the adjusting the first encoding process based on the comparison comprises increasing a target bit rate associated with the first encoding process when the comparison indicates a difference between the first encoded video content and the second encoded video content that exceeds a lower bound or an upper bound.

16. The computer-implemented method of claim 1, wherein the computer-implemented method is performed iteratively until the comparison indicates a difference between the first encoded video content and the second encoded video content is within an upper bound.

17. The computer-implemented method of claim 1, wherein the computer-implemented method is performed iteratively until the comparison indicates a difference between the first encoded video content and the second encoded video content is within a lower bound.

18. The computer-implemented method of claim 1, wherein the applying the edge detection to the compressed video content comprises applying a Canny edge detector to the compressed video content, the applying the edge detection to the equalized video content comprises applying the Canny edge detector detection to the equalized video content, or both.

19. A system comprising:
at least one processor; and
a memory storing instructions configured to instruct the at least one processor to perform:
receiving source video content;
encoding the source video content by a first encoding process to produce compressed video content;
applying edge detection to the compressed video content to produce first edge-detected video content;
encoding the first edge-detected video content by a second encoding process to produce first encoded video content;
equalizing the source video content by an equalization algorithm to produce equalized video content;
applying edge detection to the equalized video content to produce second edge-detected video content;
encoding the second edge-detected video content by the second encoding process to produce second encoded video content;
comparing the first encoded video content and the second encoded video content; and
adjusting the first encoding process based on the comparison.

20. A non-transitory computer storage medium storing computer-executable instructions that, when executed, cause a computer system to perform a computer-implemented method comprising:
receiving source video content;
encoding the source video content by a first encoding process to produce compressed video content;
applying edge detection to the compressed video content to produce first edge-detected video content;
encoding the first edge-detected video content by a second encoding process to produce first encoded video content;
equalizing the source video content by an equalization algorithm to produce equalized video content;
applying edge detection to the equalized video content to produce second edge-detected video content;
encoding the second edge-detected video content by the second encoding process to produce second encoded video content;
comparing the first encoded video content and the second encoded video content; and
adjusting the first encoding process based on the comparison.
